(19) United States
(12) Patent Application Publication
(10) Pub. No.: US 2008/0077846 A1
(43) Pub. Date: Mar. 27, 2008

(54) Table-display method, information-setting method, information-processing apparatus, table-display program, and information-setting program

(75) Inventors: Yoichiro Sako, Tokyo (JP); Takatoshi Nakamura, Ibaraki (JP); Yuichi Abe, Tokyo (JP); Mitsuru Takehara, Tokyo (JP); Itaru Kawakami, Kanagawa (JP); Toru Sasaki, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/903,663

(22) Filed: Sep. 24, 2007

(30) Foreign Application Priority Data
Sep. 26, 2006 (JP) JP2006-260493

(51) Int. Cl. G06F 17/00

(52) U.S. Cl. 715/227

(57) ABSTRACT

A table-display method is provided to display an item relating to each of sections positioned on an axis, as a table. The table-display method includes the steps of reproducing and outputting information, as additional information, when the part corresponding to a specific section of the table is displayed in a predetermined area of a display-screen image and the information is set for the specific section and/or an item relating to the specific section.

### CROSS REFERENCES TO RELATED APPLICATIONS

The present invention contains subject matter related to Japanese Patent Application JP 2006-260493 filed in the Japanese Patent Office on Sep. 26, 2006, the entire contents of which are incorporated herein by reference.

### BACKGROUND OF THE INVENTION

1. Field of the Invention

The present invention relates to a method and device that are provided to display items relating to sections positioned on an axis, as a table. Namely, each of the above-described method and device allows for displaying items relating to periods positioned on a time base, as a chronology. The present invention particularly relates to a method and a device that are provided to set information for the above-described table.

2. Description of the Related Art

It can be considered that items of historical data are written, as chronology data, and displayed, as a chronology. Further, it can also be considered that items of data on Japanese history and items of data on world history, and items of data on social background and items of data on company history, and so forth are displayed, as a synchronism.

For example, Japanese Unexamined Patent Application Publication No. 11-249640 discloses chronology data including a pair of date-and-time data and event data. According to the above-described chronology data, data on the history of a user, namely, the time period of from the user's birth to the present, is divided into time periods of several years, such as the time period of from the age of 0 to the age of 4, the time period of from the age of 5 to the age of 9, the time period of from the age of 10 to the age of 14, and so forth.

Further, according to Japanese Unexamined Patent Application Publication No. 2001-290913, article data is generated by extracting necessary information from basic data, and the generated article data is registered with an article database. Further, crude-chronology data is generated based on the article data, and a provisional index is generated by giving a provisional index code to each of articles based on the crude-chronology data. The article data is extracted from the article database based on the provisional-index code, and the style of the article data is changed into that of the main body of a document. Further, data on the photograph and/or the diagram corresponding to the main body of the document is extracted from the article database, and a visual document is generated. Thus, year-history data is generated by performing the above-described series of processing procedures.

Further, according to Japanese Unexamined Patent Application Publication No. 11-66049, when a request to display a chronology is transmitted from a user terminal to a server connected to the user terminal via a network, information about the personal history of the request source is read from a personal-event database, historical information is read from a historical-event database, and data used to display a chronology including an arrangement of the personal-history information and the historical information that are associated with each other is generated. The generated data is transmitted to the user terminal of the request source.

### SUMMARY OF THE INVENTION

However, according to the above-described known chronology-display methods, each of the chronologies simply displays items of data. Therefore, the chronology is not appealing and amusing enough to raise the user's interest. Further, the chronology is inadequate to make the user understand the background of the era and society corresponding to the chronology extensively and specifically.

According to the method disclosed in Japanese Unexamined Patent Application Publication No. 2001-290913, the chronology including the visual document showing articles, photographs, and so forth is generated and displayed. According to the above-described method, however, the user can read and understand the chronology only in a visual form. Further, since the visual document showing the photographs is included in chronology data, it is difficult for the user to make settings and/or change the chronology data. Namely, the user should add a desired visual document to article data to which no visual document is added, delete a visual document that had been added to the article data, and replace a certain visual document with a different visual document, for example, so as to make settings and/or change the chronology data.

Therefore, according to an embodiment of the present invention, a method of displaying a table such as a chronology is provided. According to the above-described method, the user is provided with information which is appealing and amusing enough to raise the user's interest, and adequate enough to make the user understand the background or the like extensively and specifically. Further, according to an embodiment of the present invention, a method of setting information for the table such as the chronology is provided. The information-setting method allows for setting desired information for the table freely. Further, after the information is set for the table, it is easy for the user to change and cancel the settings.

A table-display method according to an embodiment of the present invention is provided to display an item relating to each of sections positioned on an axis, as a table. The table-display method includes the steps of reproducing and outputting information, as additional information, when the part corresponding to a specific section of the table is displayed in a predetermined area of a display-screen image and the information is set for the specific section and/or an item relating to the specific section.

The additional information is included in information stored in a storage device and/or information existing on a network, and associated with the specific section and/or the item relating to the specific section.

Further, an information-setting method according to an embodiment of the present invention is performed when an item relating to each of sections positioned on an axis is displayed, as a table. The information-setting method includes the steps of setting specified information, or selected information for a specified section and/or a specified item included in the table, as additional information, upon being instructed to perform information setting, and storing information about a first state of the information setting in a storage device.

The information-setting method further includes the steps of setting the specified information and/or the selected information for a specific section of the table and/or an item relating to the specific section, as the additional information, upon being instructed to perform the information setting, when the part corresponding to the specific section is displayed in a predetermined area of a display-screen image, and storing information about a second state of the information setting in the storage device.

According to the above-described table-display method, when the table is displayed, the information set for the displayed section and/or the displayed item, and/or the information selected by an information-processing device for the displayed section and/or the displayed item is reproduced and output, as the additional information.

For example, when a chronology is displayed, music data set for a displayed decade and/or a displayed calendar year, and/or music data that is selected by the information-processing device for the displayed decade and/or the displayed calendar year, and that represents the decade and/or the calendar year is reproduced and output, as a background music (BGM). Otherwise, sound information obtained by recording conversations held between Apollo 1 and the control center during the moon landing, video information obtained by shooting video of an astronaut walking on the moon, or information about news reporting details on the moon landing that are set for items displayed, as information relating to a decade and/or a calendar year such as “July 1969: The first moon landing ever achieved by Apollo 11” and/or selected by the information-processing for the displayed items are reproduced and output, as sounds, video, or an article, respectively.

Accordingly, it becomes possible to provide the user with information which is appealing and amusing enough to raise the user's interest, and adequate enough to make the user understand the background or the like extensively and specifically at the chronology-display time.

According to the above-described information-setting method, the user instructs the information-processing device to perform the information setting irrespective of whether or not the table is displayed. Subsequently, information specified by the user and/or information selected by the information-processing apparatus is set for a section and/or an item specified by the user, as the additional information.

Further, when the table is displayed, the user instructs the information-processing apparatus to perform the information setting, so that the information specified by the user and/or the information selected by the information-processing apparatus is set for the displayed section and/or the displayed item, as the additional information.

Therefore, an information-setting method according to an embodiment of the present invention allows for setting desired information freely. Further, after the desired information is set, the settings can be easily cancelled and/or changed, and the set information can be reproduced and output by performing a table-display method according to an embodiment of the present invention.

Thus, a method of displaying a table such as a chronology according to an embodiment of the present invention allows for presenting information which is appealing and amusing enough to raise the user's interest, and adequate enough to make the user understand the background or the like extensively and specifically. Further, an information-setting method provided to set information for the table such as the chronology according to an embodiment of the present invention allows for setting desired information freely, and cancelling and/or changing the settings with ease after the desired information is set.

### BRIEF DESCRIPTION OF THE DRAWINGS

FIG. 1 shows a system according to an embodiment of the present invention;

FIG. 2 shows example processing procedures performed to generate and display multiple chronologies;

FIG. 3 shows an example of the generated and displayed multiple chronologies;

FIG. 4 shows another example of the generated and displayed multiple chronologies;

FIG. 5 shows another example of the generated and displayed multiple chronologies;

FIG. 6 shows example processing procedures performed by a CPU;

FIG. 7 shows an example method performed to set additional information;

FIG. 8 shows an example method of displaying chronologies after the additional information is set; and

FIG. 9 shows an example where a table other than the chronology is displayed.

### DESCRIPTION OF THE PREFERRED EMBODIMENTS

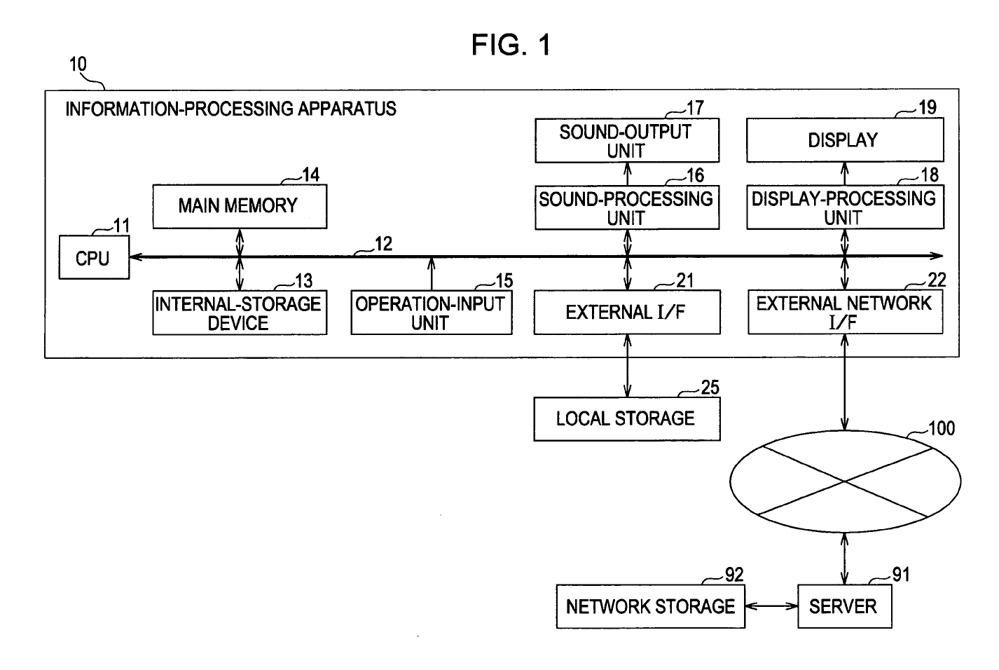

### 1. System Configuration: FIG. 1

FIG. 1 shows an example system performing a method according to an embodiment of the present invention.

In the above-described example system, an information-processing apparatus 10 provided on the user's side is connected to a server 91 via the Internet 100.

The information-processing apparatus 10 has functions of processing information and connecting to the Internet 100. The information-processing apparatus 10 further has functions of reproducing music data so that music is played and reproducing image data so that an image is displayed.

More specifically, the information-processing apparatus includes a central-processing unit (CPU) 11. An internal-storage device 13 such as a hard disk storing and retaining various types of programs including a chronology-display program and an information-setting program, and data including various types of content data, chronology data, additional information that will be described later, and so forth, and a main memory 14 where the program and/or the data is expanded are connected to a bus 12 of the information-processing apparatus 10.

Further, an operation-input unit 15 is connected to the bus 12 and a sound-output unit 17 is connected to the bus 12 via a sound-processing unit 16, and a display 19 is connected to the bus 12 via a display-processing unit 18.

The sound-processing unit 16 is configured to decode sound data such as music data, the sound-output unit 17 includes a sound-amplification circuit and a speaker (a set of headphones), the display-processing unit 18 is configured to decode image data and/or screen-image data, and the display 19 includes a liquid-crystal display and/or an organic-electroluminescence display, for example, so as to display an image and/or a screen image.

Further, an external interface 21 used to connect to an external local storage 25 and an external network interface 22 used to connect to the Internet 100 are connected to the bus 12.

The local storage 25 stores and retains data including the various content data, the chronology data, the additional information that will be described later, and so forth, and the information-processing apparatus 10 retrieves the above-described data from the local storage 25.

A server 91 presents data on various chronologies and/or contents, as Web service available on a Web site and transmits data including the chronology data and/or the content data to the information-processing apparatus 10 according to a request made by the information-processing apparatus 10. A network storage 92 accumulating data on various chronologies, contents, and so forth is connected to the server 91.

Sound information such as music information, image information such as video information, article information such as news information, and so forth are set for the chronology data transmitted from the server 91 to the information-processing apparatus 10, as additional information. The additional information is accumulated on the network storage 92, and transmitted to the information-processing apparatus 10 according to a request made by the information-processing apparatus 10.

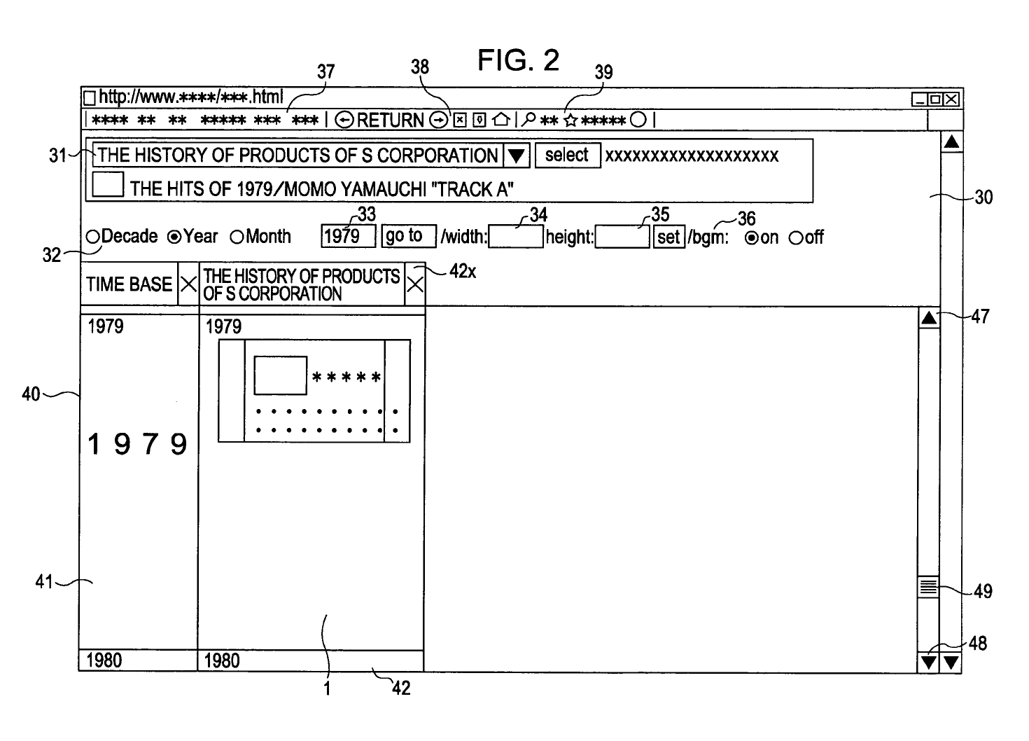

### 2. Display of Chronology and Reproduction and Output of Additional Information: FIGS. 2 to 6

According to the example system shown in FIG. 1, the information-processing apparatus 10 displays a chronology, and reproduces and outputs the additional information, as below.

The chronology data provided to display a chronology may exist on an external network and/or locally.

Hereinafter, the following cases will be described. According to the first case, multiple chronologies including an arrangement of a plurality of chronologies are generated and displayed based on chronology data existing on the external network will be described. Namely, according to an example shown in FIG. 1, the multiple chronologies are generated and displayed based on chronology data that is stored in the network storage 92 provided on the server 91's side and that is presented on the Web site. Further, according to the second case, a single chronology is displayed based on the chronology data existing on the external network. According to the third case, the multiple chronologies are generated and displayed, or the single chronology is displayed based on chronology data existing locally. Namely, according to FIG. 1, the multiple chronologies are generated and displayed, or the single chronology is displayed based on the chronology data stored in the internal-storage device 13 and/or the local storage 25. The second and third cases will be described later.

The additional information is set for a chronology (chronology data) in advance, as described above. Otherwise, the additional information is selected by the information-processing apparatus 10 and/or the server 91 when the chronology is displayed. Hereinafter, first, the case where the additional information is set for the chronology (chronology data) in advance will be described. The case where the additional information is selected by the information-processing apparatus 10 and/or the server 91 when the chronology is displayed will be described later.

### 2-1. The Case where Additional Information is Set for Chronology in Advance: FIGS. 2 to 6

### 2-1-1. When Multiple Chronologies are Generated and Displayed: FIGS. 2 to 6

FIGS. 2 to 6 show the case where music data is set for each of chronologies, as the additional information, and the multiple chronologies are generated and displayed. Setting and Acquisition of Additional information.

The music data provided, as the additional information, will be described. Namely, data on the same track is set for each of chronologies presented at a predetermined Web site. Further, in each of the chronologies, data on a track representing each of decades, calendar years, and years and months is set. Namely, for each of decades including the 1970s, the 1980s, 1990s, and so forth, data on a track representing the decade is set. Further, for each of calendar years including the 1979, the 1980, the 1981, and so forth, data on a track representing the calendar year is set. Still further, for each of years and months such as January of the 1979, February of the 1979, March of the 1979, and so forth, data on a track representing the year and the month is set.

Music data provided, as additional information of the track data, is transmitted from the server 91 to the information-processing apparatus 10 along with the chronology data, or transmitted from the server 91 to the information-processing apparatus 10 independently of the chronology data. The transmitted music data is processed by the sound-processing unit 16 of the information-processing apparatus 10, and reproduced and output from the sound-output unit 17, as a BGM.

### Generation and Display of Multiple Chronology and Reproduction and Output of Additional Information

When a user wishes to generate and display the multiple chronologies, the user starts a Web browser and makes access to the above-described Web site by operating the operation-input unit 15.

Subsequently, a chronology-display-screen image 30 shown in FIG. 2 is displayed on the display 19, for example.

More specifically, the chronology-display-screen image 30 shown in FIG. 2 shows a display-menu-selection section 31 on the upper part thereof. Under the display-menu-selection section 31, a time-base-setting section 32, a period-specification section 33, a display-width-designation section 34, a height-designation section 35, and a BGM-on/off-setting section 36 are shown. Further, a chronology-display area 40 is provided under the display-menu-selection section 31, the time-base-setting section 32, the period-specification section 33, the display-width-designation section 34, the height-designation section 35, and the BGM-on/off-setting section 36.

The display-menu-selection section 31 is provided to select any of time bases and/or various chronologies that will be described later under a pull-down-menu system. The time-base-setting section 32 is provided to determine which of “Decade”, “Year”, and “Month” should be displayed, as the time base.

The period-specification section 33 is configured to specify and/or display data on a period displayed, as the time base. The display-width-designation section 34 designates the display width (the width of a screen image) of each of chronologies displayed on the chronology-display area 40. The height-designation section 35 designates the height (the length of the screen image) of the chronology-display area 40.

If the display width is not particularly designated by the display-width-designation section 34, three chronologies of a uniform display width are arranged and displayed in the chronology-display area 40 in a direction of the width of the screen image. If the height of the chronology-display area 40 is not particularly designated by the height-designation section 35, the height of each of the chronologies for display is determined by default.

The BGM-on/off-setting unit 36 is provided to determine whether or not the music data which is set, as the additional information, in the above-described manner should be reproduced and output, as the BGM when a chronology is displayed. In the following example, it is set so that the music data is reproduced and output.

Scroll buttons 47 and 48, and a scroll bar 49 are provided on the right of the chronology-display area 40 so that a chronology displayed on the chronology-display area 40 can be scrolled in the direction of the length of the screen image.

A group of buttons 37, a group of buttons 38, and a group of buttons 39 are displayed above the display-menu-selection section 31, so as to perform various operations. The address (URL) of a Web site is shown above the button groups 37, 38, and 39, for example.

First, the user selects the time base in the display-menu-selection section 31 and specifies any of “Decade”, “Year”, and “Month” in the time-base-setting section 32.

When “Year” is specified, data on a calendar year is displayed on the left-side part of the chronology-display area 40, as a time base 41, as shown in FIG. 2. According to FIG. 2, however, “1979” is specified by the period-specification unit 33, whereby the year 1979 is displayed, as the time base 41.

When the user selects a chronology titled, as “The history of products of S corporation”, from among various chronologies presented at the Web site in the display-menu-selection section 31 in that state, the information-processing apparatus 10 acquires data on the above-described chronology. Then, the CPU 11 arranges and displays the above-described chronology, that is, chronology 1 on a left-side area 42 adjacent to the time base 41 shown in the chronology-display area 40, as shown in FIG. 2. Further, the title of chronology 1 and a button 42x provided to close chronology 1 are displayed on the left-side area 42.

Chronology 1 shows the history of products of S corporation. FIG. 2 shows photographs and description of one of the products, that is, a single product representing products put on the market in the year 1979.

At the same time, music data set for the period corresponding to the year 1979 shown in chronology 1, as the additional information, for example, data on a track A which is a hit of the year 1979 is reproduced and output, as the BGM. Data on the artist, title, and jacket photograph of the track A is displayed on the lower part of the display-menu-selection section 31 of the chronology-display-screen image 30.

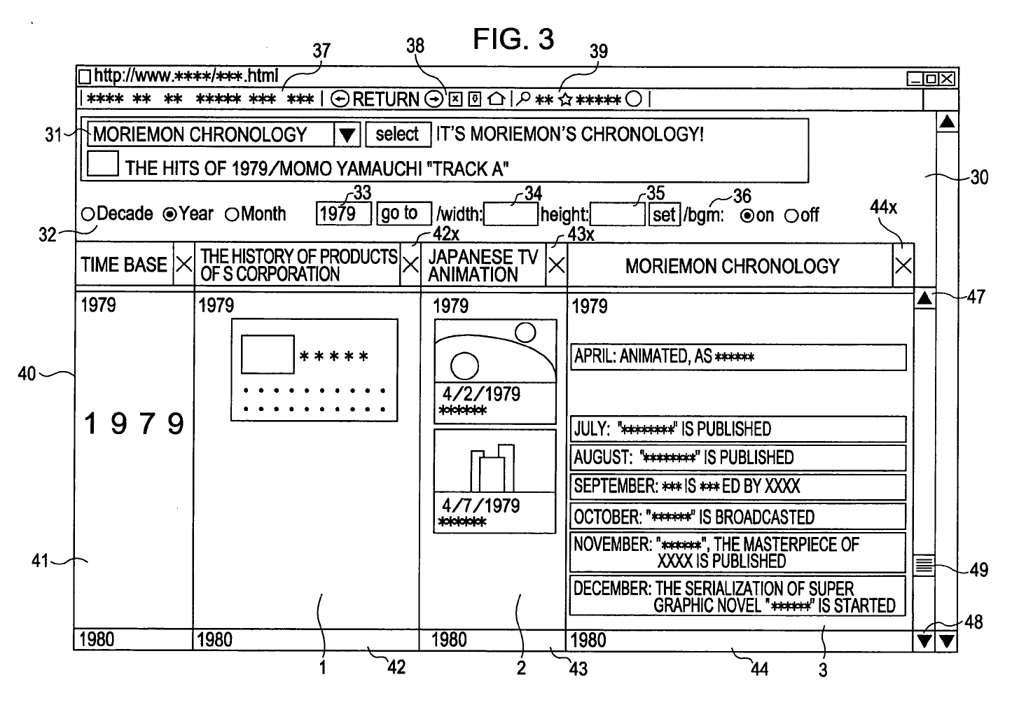

When the user selects a chronology titled, as “Japanese TV animations”, from among various chronologies presented at the Web site in the display-menu-selection section 31 in the above-described state, the information-processing apparatus 10 acquires data on the selected chronology. Then, the CPU 11 arranges and displays the above-described chronology, that is, chronology 2 on a center area 43 adjacent to the area 42 shown in the chronology-display area 40, as shown in FIG. 3. Further, the title of chronology 2 and a button 43x provided to close chronology 2 are displayed on the center area 43.

Chronology 2 shows the history of Japanese TV animations. FIG. 3 shows images indicating two animations broadcasted in the year 1979, where the two animations represent Japanese TV animations.

At the same time, music data is set for the period corresponding to the year 1979 shown in chronology 2, as the additional information, is reproduced and output, as the BGM.

In that case, however, data on the same track is set for the same year shown in each of the chronologies, as described above. Therefore, reproduction and output of data on the track A are continued without returning to the top of the track A, where the data on the track A is reproduced and output at the time where chronology 1 is displayed before chronology 2 is displayed.

Further, when the user selects a chronology titled, as “Moriemon Chronology”, from among various chronologies presented at the Web site in the display-menu-selection section 31 in the above-described state, the information-processing apparatus 10 acquires data on the selected chronology. Then, the CPU 11 arranges and displays the above-described chronology, that is, chronology 3 on a right-side area 44 adjacent to the center area 43 shown in the chronology-display area 40, as shown in FIG. 3. Further, the title of chronology 3 and a button 44x provided to close chronology 3 are displayed on the right-side area 43.

Chronology 3 shows the history of a graphic novel featuring a hero named as “Moriemon”, the history describing from the birth, publication, animation, and so forth to the present status of the graphic novel. FIG. 3 displays seven events occurred in the year 1979 of the history.

At the same time, reproduction and output of music data set for the period corresponding to the year 1979 shown in chronology 3, as the additional information, that is, data on the above-described track A, are continued without returning to the top of the track A.

According to the above-described method, three chronologies 1, 2, and 3 are arranged and displayed in the chronology-display area 40 of the chronology-display-screen image 30 in the direction of the width of the screen image so that multiple chronologies are generated. Further, during and after generation of the multiple chronologies, the music data set, as the additional information, is reproduced and output, as the BGM.

According to FIG. 3, the chronology-display area 40 only shows part of each of the chronologies, the part showing data relating to the year 1979. All of acquired data items are expanded and retained on the main memory 14 and a display memory provided in the display-processing unit 18, as chronology data. A range starting backward from the year 1978 shown in each of the chronologies and a range starting forward from the year 1980 shown in each of the chronologies are displayed in the chronology-display area 40 through a scroll operation achieved by operating the scroll buttons 47 and 48, and/or the scroll bar 49.

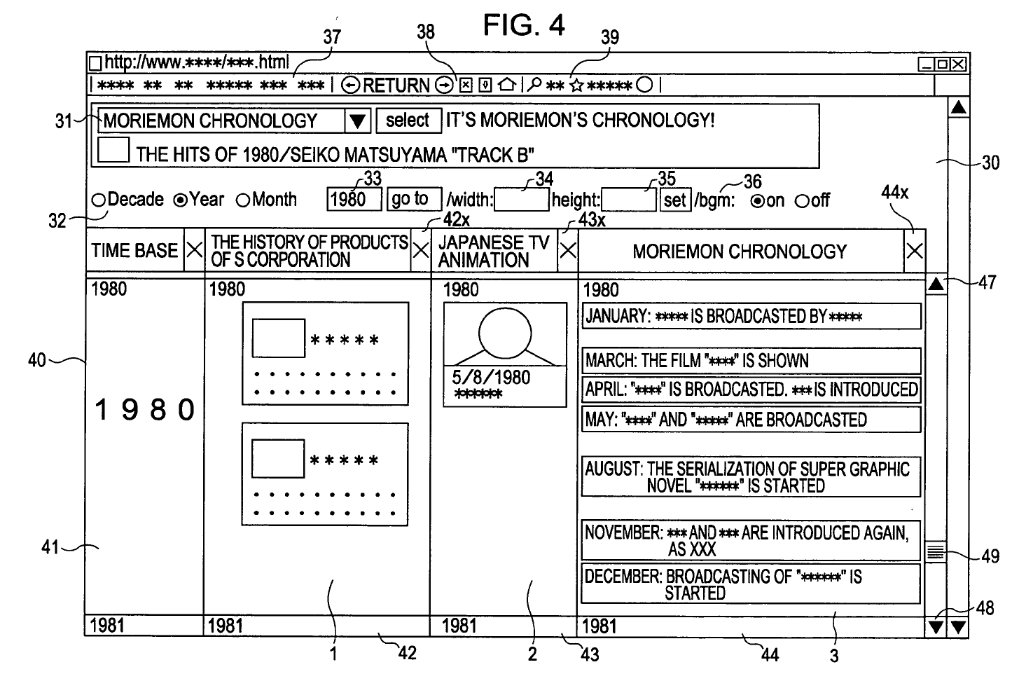

FIG. 4 shows the case where part of each of the chronologies is displayed, the part corresponding to the year 1980. Chronology 1 shows two data items, chronology 2 shows a single data item, and chronology 3 shows seven data items.

When the part corresponding to the year 1980 shown in each of the chronologies is displayed in the above-described manner, music data set for the period corresponding to the year 1980 shown in each of the chronologies, as the additional information, for example, data on a track B which is a hit of the year 1980 is reproduced and output, as the BGM. Data on the artist, title, and jacket photograph of the track B is displayed on the lower part of the display-menu-selection section 31 of the chronology-display-screen image 30.

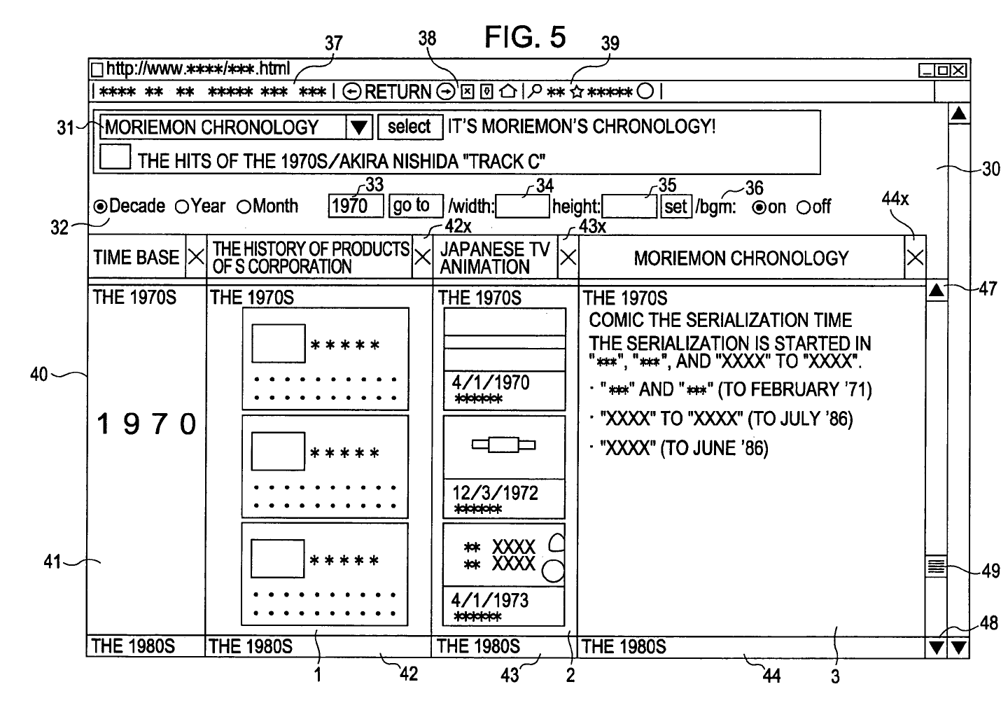

When the user specifies “Decade” in the time-base-setting section 32 when selecting a time base in the display-menu-selection section 31, and selects the chronology titled, as “the history of products of S corporation”, the chronology titled, as “Japanese TV animations”, and the chronology titled, as “Moriemon chronology” in sequence in the display-menu-selection section 31 in the above-described manner, a zoom-out operation is performed so that data on a date shown in decades is displayed in the chronology-display area 40, as the time base 41, as shown in FIG. 5. Further, parts showing the above-described date of chronologies 1, 2, and 3 are displayed in the areas 42, 43, and 44, respectively, so that multiple chronologies are generated.

However, according to FIG. 5, data read as “the 1970s” is displayed, as the time base 41, and photographs and descriptions illustrating three products put on the market in the 1970s, the three products representing products of S corporation, are displayed, as chronology 1. Chronology 2 shows images indicating three animations representing the Japanese TV animations, the three animations being broadcasted in the 1970s, for example. Chronology 3 shows several events relating to the graphic novel “Moriemon”, where the several events occurred in the 1970s, for example.

At that time, music data set for the period corresponding to the 1970s shown in each of the chronologies, as the additional information, for example, data on a track C which is the greatest hit of the 1980s is simultaneously reproduced and output, as the BGM. Data on the artist, title, and jacket photograph of the track C is displayed on the lower part of the display-menu-selection section 31 of the chronology-display-screen image 30.

When the user specifies “Month” in the time-base-setting section 32 when selecting the time base in the display-menu-selection section 31, and selects the chronology titled, as “the history of products of S corporation”, the chronology titled, as “Japanese TV animations”, and the chronology titled, as “Moriemon chronology” in sequence in the display-menu-selection section 31 in the above-described manner, a zoom-in operation is performed so that data on a date shown in months is displayed in the chronology-display area 40, as the time base 41, though not shown. Further, parts showing the above-described date of chronologies 1, 2, and 3 are displayed in the areas 42, 43, and 44, respectively, so that multiple chronologies are generated.

In that case, the music data set for each of the chronologies, as the additional information, is reproduced and output, as the BGM. However, when the parts corresponding to months shown in the chronology are displayed, the system may be configured so that data on a track is not set on a month-by-month basis, that is to say, the tracks set for different months are not different from one another. Further, the system may be configured so that data on a track set for each of calendar years in the above-described manner is set for each of months, that is, from January to December of the concerned calendar year, and the track-A data is reproduced and output even though a displayed part of the chronology corresponds to any of months, that is, from January to December of the year 1979. Editing and Storage of Multiple Chronologies

Editing including replacement and/or sorting of chronology data can be performed for the multiple chronologies generated in the above-described manner.

As for the chronology replacement, chronology data which is acquired separately can be arranged and displayed in the chronology-display area 40 in place of part of and/or the entire chronologies arranged and displayed in the chronology-display area 40. For example, in the state shown in FIG. 3, chronology 1 (the history of products of S corporation) can be closed by operating the button 42x, data on a different chronology can be selected in the display-menu-selection section 31, and the different chronology can be arranged and displayed in the area 42.

The chronology sorting is performed in the following manner, for example. Namely, as shown in FIG. 3, multiple chronologies includes chronology 1 (the history of products of S corporation) arranged and displayed in the left-side area 42 provided in the chronology-display area 40, chronology 2 (Japanese TV animations) arranged and displayed in the center area 43, and chronology 3 (Moriemon Chronology) arranged and displayed in the right-side area 44. The chronologies on the left side and the right side of the multiple chronologies, that is, chronologies 1 and 3 are replaced with each other, whereby multiple chronologies can be generated, the multiple chronologies including chronology 3 (Moriemon Chronology) arranged and displayed on the left-side area 42 provided in the chronology-display area 40, chronology 2 (Japanese TV animations) arranged and displayed on the center area 43, and chronology 1 (the history of products of S corporation) arranged and displayed in the right-side area 44.

Data on the multiple chronologies generated in the above-described manner may be stored in the internal-storage device 13 and/or the local storage 25. The above-described editing is one of the steps of generating the multiple chronologies.

At that time, the music data acquired by the information-processing apparatus 10 in the above-described manner, as the additional information, should be stored in the internal-storage device 13 and/or the local storage 25 in association with data on the above-described multiple chronologies. In that case, the music data stored, as the additional information, can be reproduced and output when the multiple chronologies are displayed on the display 19 at another opportunity.

### Processing Performed by CPU of Information-Processing Device

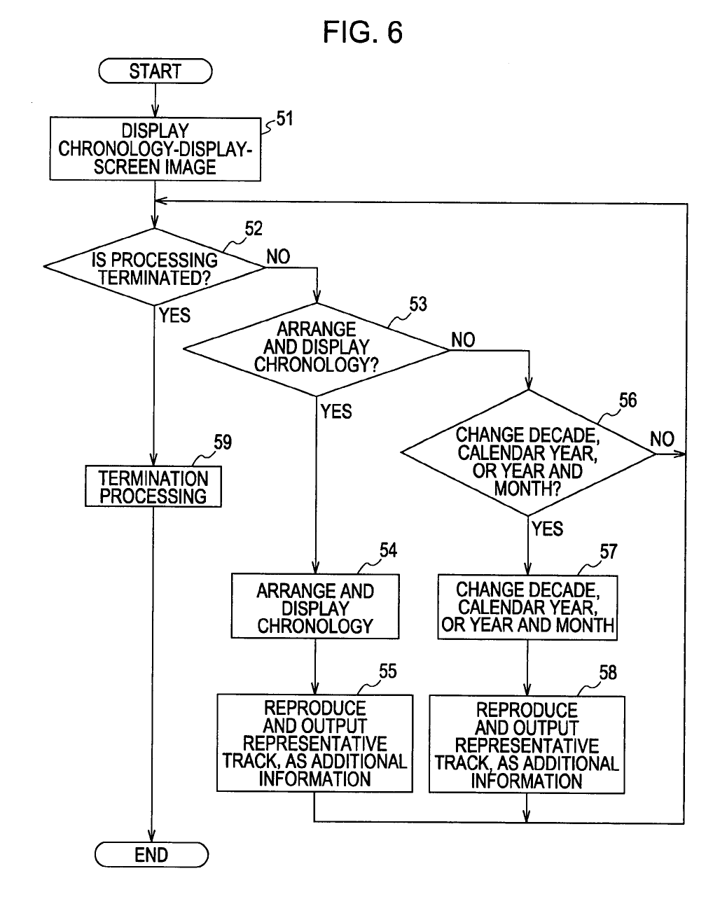

FIG. 6 shows example processing performed by the CPU 11 of the information-processing apparatus 10 when the multiple chronologies are generated and displayed, and the music data provided, as the additional information, is reproduced and output, as described above.

However, FIG. 6 does not show particulars of the example processing, such as processing performed when the user selects the time base in the menu-selection section 31. Further, in the BGM-on/off-setting section 36, the button “on” is selected so that the BGM is played.

According to the example processing shown in FIG. 6, an access to the Web site presenting the various chronologies is made so that the entire processing is started. First, at step 51, the chronology-display-screen image 30 shown in FIG. 2 is displayed on the display 19. At that time, however, no chronology is arranged and displayed in the chronology-display area 40.

Next, at step 52, it is determined whether or not the entire processing should be terminated. When the user terminates the entire processing by closing the chronology-display-screen image 30, for example, the processing advances to step 59 so that termination processing which will be described later is performed, and the entire processing is terminated. When the entire processing should not be terminated, the processing advances to step 53 where it is determined whether or not a chronology should be arranged and displayed.

Then, if the user selects a chronology, the processing advances from step 53 to step 54 where the selected chronology is arranged and displayed. The processing further advances to step 55 so that data on a representative track is reproduced and output, as the additional information, and the processing returns to step 52.

On the other hand, if the user selects no chronology, the processing advances from step 53 to step 56 where it is determined whether or not data on a decade, a calendar year, or a year and a month for display should be changed.

When the user changes the data on the decade, the calendar year, or the year and the month for display by performing the above-described scroll operation, the processing advances from step 56 to step 57 so that the data on the decade, the calendar year, or the year and the month is changed in response to the scroll operation. Further, the processing advances to step 58 so that the representative-track data provided, as the additional information, is reproduced and output according to the change in the data on the decade, the calendar year, or the year and the month for display. After that, the processing returns to step 52.

If it is determined that the data on the decade, the calendar year, or the year and the month for display should not be changed, at step 56, the processing returns to step 52.

At step 59, termination processing is performed, as below. Namely, the user is asked whether or not data on the generated multiple chronologies should be stored. If the user instructs to store the multiple-chronology data and designates a storage destination in response to the above-described inquiry, the generated multiple-chronology data is stored in the designated storage destination.

### When Additional Information is Set for Item Relating to Period

The additional information may be set for an item relating to a period including a decade, a calendar year, or a year and a month, the period being shown in each of the chronologies.

For example, when the multiple chronologies are generated and displayed, as shown in FIG. 3, a track is set for a single item of the period corresponding to the year 1979 shown in chronology 1, two different tracks are set for two items of the period corresponding to the year 1979 shown in chronology 2, respectively, and seven different tracks are set for seven items of the period corresponding to the year 1979 shown in chronology 3, respectively.

In that case, for example, when chronology 1 is activated and the period corresponding to the year 1979 shown therein is displayed, the data on the track set for the single item is reproduced and output. When chronology 2 is activated and the period corresponding to the year 1979 shown therein is displayed, and the user specifies at least one of the two items by performing a click operation or the like, the track data set for the specified item is reproduced and output. Particularly, when the user does not specify any of the two items, the data on the two tracks set for the two items is reproduced and output so that the two tracks are played in sequence. Similarly, when chronology 3 is activated and the period corresponding to the year 1979 shown therein is displayed, and the user specifies at least one of the seven items, the track data set for the specified item is reproduced and output. Particularly, when the user does not specify any of the seven items, the data on the seven tracks set for the seven items is reproduced and output so that the seven tracks are played in sequence. After the multiple chronologies including chronologies 1, 2, and 3 displayed in an arrangement are generated, the data on the track set for the item that is specified by the user and that is shown in any of chronologies 1, 2, and 3 is reproduced and output. Especially, when the user does not specify a particular item, data on a representative track is reproduced and output. For example, the data on the track set for chronology 1 is reproduced and output. Here, activation of chronology N denotes explicitly notifying the CPU that the chronology N is an operation subject by specifying the chronology N through the click operation or the like.

### 2-1-2. When a Single Chronology is Displayed

The above-described configuration can be used for generating and displaying the multiple chronologies. However, a single chronology can also be displayed in the chronology-display area of the chronology-display-screen image by using the above-described configuration.

### 2-1-3. When Chronology Data Exists Locally

The above-described configuration can be used when chronology data exists on an external network. However, the above-described configuration can also be used when the chronology data exists locally.

More specifically, when the chronology data exists locally, the information-processing apparatus 10 displays various chronologies of which data is stored in the internal-storage device 13 and/or the local storage 25 in the chronology-display-screen image so that the user can select any of the chronologies.

### 2-2. When Additional Information is Selected While Chronology is Displayed

According to each of the above-described embodiments, the music data is set for the chronology in advance, as the additional information. However, when the chronology is displayed, the track data can be selected by the information-processing apparatus 10 and/or the server 91, as the additional information.

For example, when it is configured that the information-processing apparatus 10 selects the music data and a specific period such as the period corresponding to the year 1979 is displayed, the CPU 11 selects information associated with the specific period from among information stored in the internal-storage device 13 and/or the local storage 25, as the additional information, and reproduces and outputs the selected information.

When it is configured that the server 91 selects the music data, the information-processing apparatus 10 notifies the server 91 of a period which is currently displayed in the chronology-display area of the chronology-display-screen image, as the time base, and requests the server 91 to select and transmit the additional information. Upon receiving the above-described request, the server 91 selects information associated with the displayed period from among information stored in the network storage 92, as the additional information, and transmits the additional information to the information-processing apparatus 10. Upon receiving the additional information, the information-processing apparatus 10 reproduces and outputs the additional information.

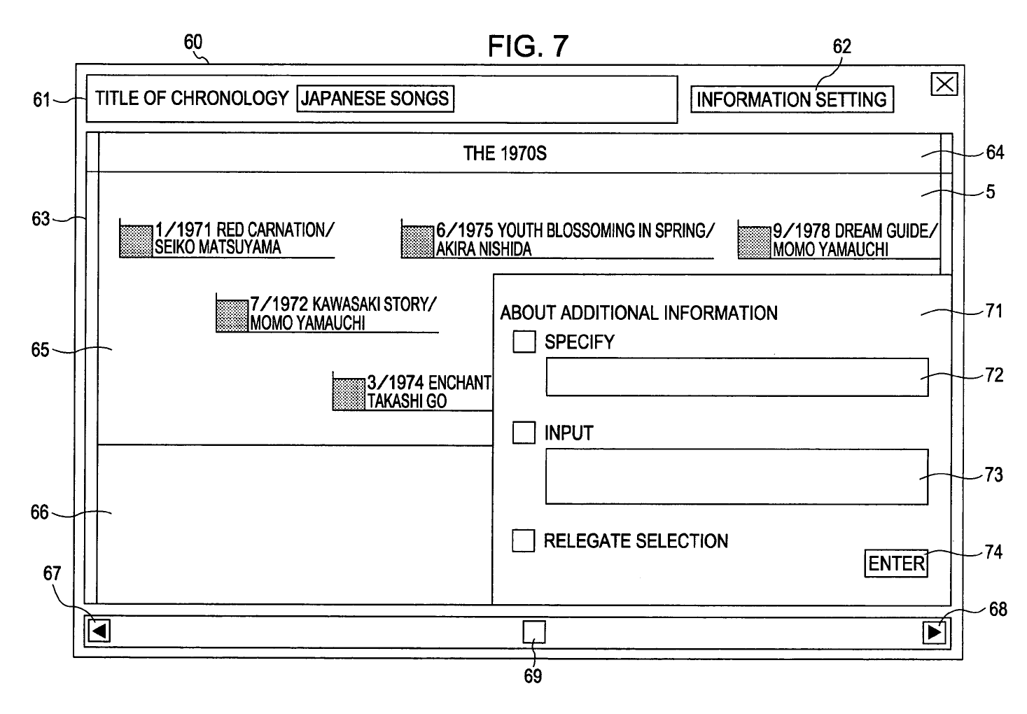

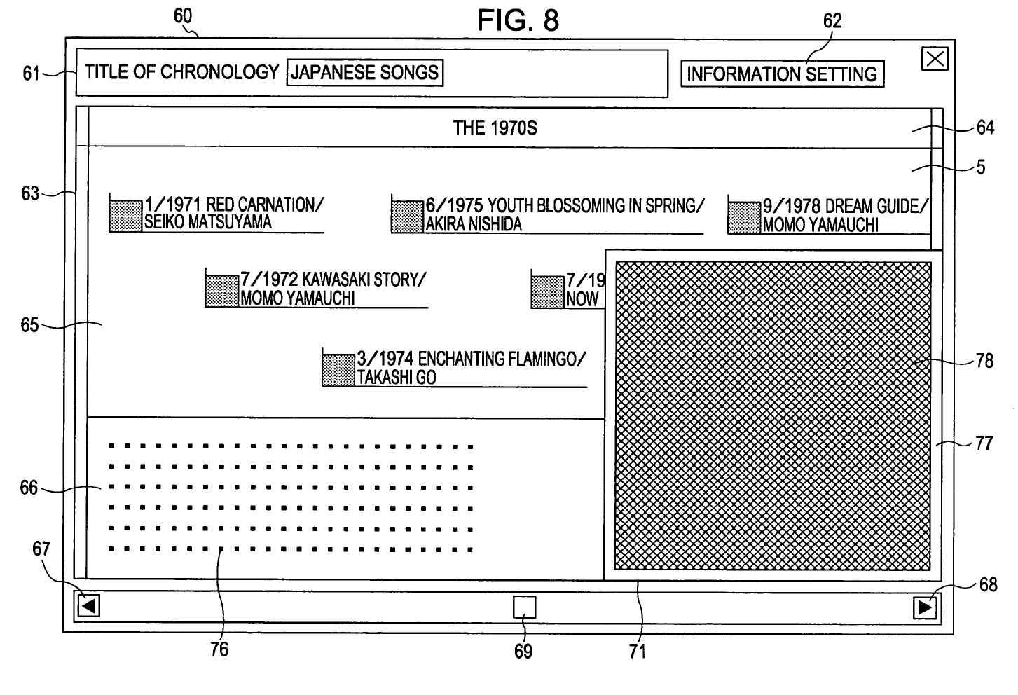

### 3. Information-Setting Method: FIGS. 7 and 8

According to the example system shown in FIG. 1, the information-processing apparatus 10 sets additional information for a chronology in the following manner, so as to display the chronology, and reproduce and output the additional information in the above-described manner.

### 3-1. Setting of Additional Information While Chronology is Displayed: FIGS. 7 and 8

According to an example method, the setting of the additional information is performed under an instruction from the user while the chronology is displayed in the chronology-display area of the chronology-display-screen image.

For example, in FIG. 7, a chronology-display-screen image 60 shows a title section 61 in the upper part thereof. An information-setting button 62 is provided on the right of the title section 61, and a chronology-display area 63 is provided under the title section 61. A time base 64 is displayed in the upper-side part of the chronology-display area 63. The part shown under the time base 64, that is, the lower part of the chronology-display area 63 is divided into an item-display section 65 and an additional-information-display section 66.

Scroll buttons 67 and 68, and a scroll bar 69 are provided under the chronology-display area 63 so that a chronology displayed in the chronology-display area 63 can be scrolled in a direction of the width of the screen image.

According to FIG. 7, the chronology-display area 63 shows the period corresponding to the 1970s shown in chronology 5 titled as “Japanese Songs”.

When the user operates the information-setting button 62 in that state, a setting-screen image 71 is displayed on the lower-right part of the chronology-display area 63.

The setting-screen image 71 is provided for the user so that the user gives an instruction to designate the additional information, input data on an article, as the additional information, or relegate selection of the additional information to the information-processing apparatus 10, for example.

When file data including data on an image, an article, and so forth that are appropriate, as information associated with the 1970s, is stored in the internal-storage device 13 and/or the local storage 25, the user may place a checkmark in the box “specify”, input data on the name of the data file in a specification field 72, and operate an enter button 74.

Subsequently, the CPU 11 of the information-processing apparatus 10 can set the file data, as the additional information corresponding to the period of the 1970s shown in chronology 5.

When the user wishes to input data on an article on his/her own, as the additional information, the user may place a checkmark in the box “input data”, input the article data to an input field 73, and operate the enter button 74.

Subsequently, the CPU 11 of the information-processing apparatus 10 determines the input article data to be the file data, gives a name to the file data, and determines the file data to be the additional information set for the period corresponding to the 1970s shown in chronology 5.

Further, when the user relegates the selection of the additional information to the information-processing apparatus 10, the user may place a checkmark in the box “relegate selection”, and operate the enter button 74.

Subsequently, the CPU 11 of the information-processing apparatus 10 selects data appropriate, as the additional information set for the period corresponding to the 1970s shown in chronology 5, from among data stored in the internal-storage device 13 and/or the local storage 25, and determines the selected data, as the additional information set for the period corresponding to the 1970s shown in FIG. 5.

The user may perform the above-described operations again and again so that a plurality of data items is determined to be the additional information set for the same period of the same chronology.

Further, when the user displays the period corresponding to a different decade shown in chronology 5 in the chronology-display area 63 by performing the scroll operation, and performs the above-described operations, additional information can be set for the period corresponding to the different decade shown in chronology 5.

When the additional information is set in the above-described manner, the additional information is reproduced and output immediately, as shown in FIG. 8. FIG. 8 shows an example where data on an article 76 and an image 78 is set for the period corresponding to the 1970s shown in chronology 5, as the additional information. The article data 76 is displayed on an article-display section 66, and the image data 78 is displayed on an image-display area 77 provided in the lower-right part of the chronology-display area 63.

The additional information can be set for an item relating to a specific period. In that case, for example, the user may designate an item for which the additional information is to be set by performing the click operation or the like before and/or after operating the button 62 while data on the specific period is displayed, as shown in FIG. 7.

### 3-2. Setting of Additional Information When No Chronology is Displayed

The additional information can be set for a chronology for which the additional information is to be set when the chronology is not displayed.

In that case, the user may open a setting-screen image, designate the above-described chronology, and designate a period and/or an item for which the additional information is to be set on the setting-screen image. Further, the user may designate and/or input the additional information, and/or relegate selection of the additional information to the information-processing apparatus 10 in the above-described manner.

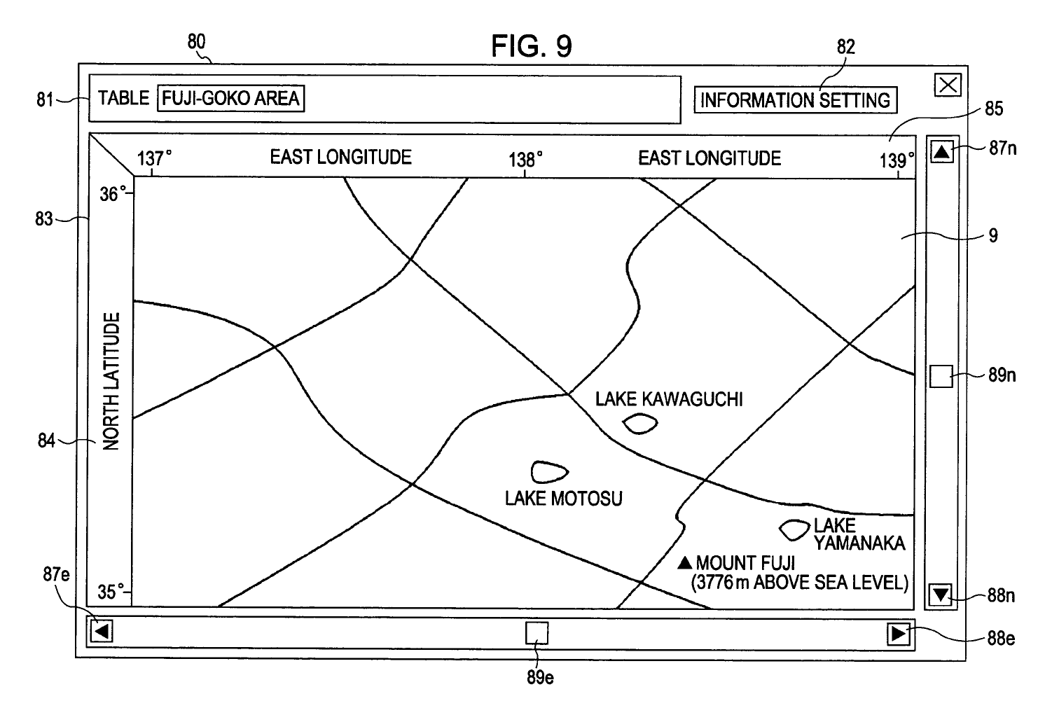

### 4. Other Examples and Embodiments: FIG. 9

### 4-1. Description of Time Base

According to the above-described embodiments, data on a decade, a calendar year, or a year and a month is displayed, as the time base, and chronology data is displayed. However, according to another embodiment of the present invention, not only the chronology data is displayed, but also items relating to periods positioned on the time base are displayed, as a table.

More specifically, the time base may be displayed, as

(a) data on a century including the nineteenth century, the twentieth century, the twenty-first century, and so forth,

(b) data on a decade, a calendar year, and/or a year and a month, as in the above-described embodiments,

(c) data on a time period measured in days, hours, minutes, and/or seconds, and

(d) data on another time period.

When the data on another time period is shown, as the time base, the number, time, and place of an event held at regular time intervals, for example, every four years are shown, as “The First Event held in July 1955, France, The Second Event held in June 1959, England, The Third Event held in July 1963, Germany”, for example. Further, the time base may be shown, as data on time periods extending over a plurality of frames, or a plurality of samples. In that case, the time-period data may be displayed, as “the first frame, the second frame, and the third frame”, or “the first sample, the second sample, and the third sample”.

### 4-2. Axis Other than Time Base: FIG. 9

Further, according to another embodiment of the present invention, not only items relating to periods positioned on the above-described time base are displayed, as a table such as a chronology, but also items relating to sections positioned on a timelike axis, a spacelike axis, a regional and/or spatial axis, or a classificatory and/or rank-oriented axis are displayed, as the table.

The above-described configuration is shown in FIG. 9, for example. In FIG. 9, a table-display-screen image 80 shows a title section 81 on the upper part thereof. Further, an information-setting button 82 is provided on the right of the title section 81 and a table-display area 83 is provided under the title section 81. The table-display area 83 shows a latitude axis 84 on the left-side part thereof and a longitude axis 85 on the upper-side part thereof, for example.

Further, a scroll buttons 87n and 88n, and a scroll bar 89n are provided on the right of the table-display area 83 so that a table displayed in the table-display area 83 can be scrolled in a direction of the length of the screen image (the latitude direction). Further, scroll buttons 87e and 88e, and a scroll bar 89e are provided under the table-display area 83 so that the table displayed in the table-display area 83 can be scrolled in a direction of the width of the screen image (the longitude direction).

According to FIG. 9, the table-display area 83 shows the area (section) of from 35 degrees north latitude to 36 degrees north latitude and from 137 degrees east longitude to 139 degrees east longitude, where data on the area is shown in Table 9 titled, as “Fuji-goko area”. Table 9 shows data on roads, as is the case with a map, and/or features or the like of areas, as items.

When the user operates the button 82 in the above-described state, music data or the like can be set for the area of from 35 degrees north latitude to 36 degrees north latitude and from 137 degrees east longitude to 139 degrees east longitude shown in Table 9, as the additional information, according to the same method as that shown in FIG. 7.

Further, when the table-display area 83 shows the area of from 35 degrees north latitude to 36 degrees north latitude and from 137 degrees east longitude to 139 degrees east longitude of Table 9, as shown in FIG. 9, after the music data is set in the above-described manner, as the additional information, the music data is reproduced and output.

When the above-described configuration is used for a navigation system and when it is configured that Table 9 is automatically moved in the table-display area 83 instead of performing the above-described scroll operation so that the current position of a traveling vehicle and/or a walking user is displayed in the table-display area 83 at all times, the user can enjoy a music associated with each of areas without changing tracks, as the vehicle and/or the user moves.

Further, the table-display area 83 may not display the latitude axis 84 and the longitude axis 85.

Further, it may be configured that a map image is shifted for each of railroads and/or routes of an aircraft, and/or service areas of a highway, and music data reproduced and output is changed by shifting from a point to another, where the point denotes a place name, a station name, and so forth, in place of scrolling the map image based on latitudes and/or longitudes.

Further, without being limited to the case where a displayed area is shifted, when zooming in and out on the displayed area with reference to a specific point determined to be the center point, it may be configured that music data or the like reproduced and output according to the zooming in and out is changed.

For example, even though the image of a facility referred to as “Blue-sky world”, the facility being provided in a large facility referred to as “Tokyo global land”, is shown at the center of the map image, music data reproduced and output may be changed according to the scale of the map image. Namely, when the smallest scale is achieved (when the displayed area is minimized in size), a track D which is the theme track of the facility “Blue-sky world” may be played. However, a track E representing “Tokyo global land”, a track F representing Tokyo, and the national anthem of Japan may be played, as the scale is increased (as the displayed area is increased in size).

It should be understood by those skilled in the art that various modifications, combinations, sub-combinations and alterations may occur depending on design requirements and other factors insofar as they are within the scope of the appended claims or the equivalents thereof.

What is claimed is:

1. A table-display method provided to display an item relating to each of sections positioned on an axis, as a table, the table-display method comprising the steps of reproducing and outputting information, as additional information, when the part corresponding to a specific section of the table is displayed in a predetermined area of a display-screen image and the information is set for the specific section and/or an item relating to the specific section.

2. The table-display method according to claim 1, wherein the additional information is included in information stored in a storage device and/or information existing on a network, and associated with the specific section and/or the item relating to the specific section.

3. An information-setting method performed when an item relating to each of sections positioned on an axis is displayed, as a table, the information-setting method comprising the steps of:
setting specified information, or selected information for a specified section and/or a specified item included in the table, as additional information, upon being instructed to perform information setting; and
storing information about a first state of the information setting in a storage device.

4. The information-setting method according to claim 3, further comprising the steps of:
setting the specified information and/or the selected information for a specific section of the table and/or an item relating to the specific section, as the additional information, upon being instructed to perform the information setting, when the part corresponding to the specific section is displayed in a predetermined area of a display-screen image; and
storing information about a second state of the information setting in the storage device.

5. An information-processing apparatus provided to display an item relating to each of sections positioned on an axis, as a table, the information-processing apparatus comprising:
operation-input means;
processing means provided to process first table data stored in a storage device and/or second table data acquired from a network and display the part corresponding to a specific section of the table in a predetermined area of a display-screen image; and
control means provided to reproduce and output information set for the specific section and/or an item relating to the specific section, as additional information, when the processing means displays the part corresponding to the specific section in the predetermined area.

6. The information-processing apparatus according to claim 5, wherein the additional information is included in information stored in the storage device and/or information existing on the network, and associated with the specific section and/or the item relating to the specific section.

7. The information-processing apparatus according to claim 5, wherein the control means sets specified information and/or selected information for a specified section and/or a specified item included in the table, as the additional information, upon being instructed to perform information setting by the operation-input means, and stores information about a state of the information setting in the storage device.

8. The information-processing apparatus according to claim 7, wherein the control means sets the additional information for the specific section and/or the item relating to the specific section, upon being instructed to perform the information setting by the operation-input means, when the processing means displays the part corresponding to the specific section of the table in the predetermined area.

9. A recording medium storing a table-display program making a computer function, as means for reproducing and outputting information set for a specific section of a table, and/or a first item relating to the specific section, as additional information, when the part corresponding to the specific section is displayed in a predetermined area of a display-screen image, so as to display a second item relating to each of sections positioned on an axis, as the table.

10. The recording medium according to claim 9, wherein the additional information is included in information stored in a storage device and/or information existing on a network, and associated with the specific section and/or the first item relating to the specific section.

11. A recording medium storing an information-setting program making a computer execute the steps of:
setting specified information and/or selected information for a specified section and/or a specified item included in a table, as additional information, upon being instructed to perform information setting; and
storing information about a state of the information setting in a storage device,
so as to set information for the table when an item relating to each of sections positioned on an axis is displayed, as the table.

12. The recording medium according to claim 11, wherein, at the setting step, the specified information and/or the selected information is set for a specific section of the table and/or an item relating to the specific section, as the additional information, upon being instructed to perform the information setting, when the part corresponding to the specific section is displayed in a predetermined area of a display-screen image.

13. An information-processing apparatus provided to display an item relating to each of sections positioned on an axis, as a table, the information-processing apparatus comprising:
an operation-input unit;
a processing unit provided to process first table data stored in a storage device and/or second table data acquired from a network and display the part corresponding to a specific section of the table in a predetermined area of a display-screen image; and
a control unit provided to reproduce and output information set for the specific section and/or an item relating to the specific section, as additional information, when the processing unit displays the part corresponding to the specific section in the predetermined area.

14. A recording medium storing a table-display program making a computer function, as a unit provided to reproduce and output information set for a specific section of a table, and/or a first item relating to the specific section, as additional information, when the part corresponding to the specific section is displayed in a predetermined area of a display-screen image, so as to display a second item relating to each of sections positioned on an axis, as the table.
